(19) United States
(12) Patent Application Publication
(10) Pub. No.: US 2017/0294184 A1
(43) Pub. Date: Oct. 12, 2017

(54) Segmenting Utterances Within Speech

(71) Applicant: KnuEdge Incorporated, San Diego, CA (US)

(72) Inventors: David C. Bradley, La Jolla, CA (US); Jeremy Semko, San Diego, CA (US); Sean O'Connor, San Diego, CA (US)

(21) Appl. No.: 15/372,205

(22) Filed: Dec. 7, 2016

Related U.S. Application Data
(60) Provisional application No. 62/320,273, filed on Apr. 8, 2016.

(51) Int. Cl. G10L 15/04; G10L 17/02; G10L 25/21; G10L 15/14

(52) U.S. Cl. CPC G10L 15/04; G10L 15/14; G10L 17/02; G10L 25/21

(57) ABSTRACT

The technology described in this document can be embodied in a computer-implemented method that includes obtaining a plurality of portions of a speech signal, and obtaining a plurality of frequency representations by computing a frequency representation of each portion of the speech signal. The method also includes generating, by one or more processing devices, a time-varying data set using the plurality of frequency representations by computing an entropy of each frequency representation of the plurality of frequency representations, and determining, by the one or more processing devices, boundaries of a speech segment using the time-varying data set. The method further includes classifying the speech segment into a first class of a plurality of classes, and processing the speech signal using the first class of the speech segment.

### PRIORITY CLAIM

This application claims priority to U.S. Provisional Application 62/320,273, filed on Apr. 8, 2016, the entire content of which is incorporated herein by reference.

### TECHNICAL FIELD

This document relates to signal processing techniques used, for example, in speech processing.

### BACKGROUND

Segmentation techniques are used in speech processing to divide the speech into utterances such as words, syllables, or phonemes.

### SUMMARY

In one aspect, this document features a computer-implemented method that includes obtaining a plurality of portions of a speech signal, and obtaining a plurality of frequency representations by computing a frequency representation of each portion of the speech signal. The method also includes generating, by one or more processing devices, a time-varying data set using the plurality of frequency representations by computing an entropy of each frequency representation of the plurality of frequency representations, and determining, by the one or more processing devices, boundaries of a speech segment using the time-varying data set. The method further includes classifying the speech segment into a first class of a plurality of classes, and processing the speech signal using the first class of the speech segment.

In another aspect, this document features a transformation engine, a segmentation engine, and a classification engine, each including one or more processing devices. The transformation engine is configured to obtain a plurality of portions of a speech signal, and obtain a plurality of frequency representations by computing a frequency representation of each portion of the speech signal. The segmentation engine is configured to generate a time-varying data set using the plurality of frequency representations by computing an entropy of each frequency representation of the plurality of frequency representations, and determine boundaries of a speech segment using the time-varying data set. The classification engine is configured to classify the speech segment into a first class of a plurality of classes, and generate an output representing the first class, and process the speech signal using the first class of the speech segment.

In another aspect, this document features one or more machine-readable storage devices having encoded thereon computer readable instructions for causing one or more processors to perform various operations. The operations include obtaining a plurality of portions of a speech signal, and obtaining a plurality of frequency representations by computing a frequency representation of each portion of the speech signal. The operations also include generating a time-varying data set using the plurality of frequency representations by computing an entropy of each frequency representation of the plurality of frequency representations, and determining boundaries of a speech segment using the time-varying data set. The operations further include classifying the speech segment into a first class of a plurality of classes, and processing the speech signal using the first class of the speech segment.

Implementations of the above aspects may include one or more of the following features.

Computing the frequency representation can include computing a stationary spectrum. Computing the entropy for each frequency representation can include obtaining a plurality of amplitude values from the frequency representation, computing, for each of the plurality of amplitude values, a corresponding time derivative value and a corresponding frequency derivative value, and computing the entropy using the plurality of amplitude values, the corresponding time derivative values, and the corresponding frequency derivative values. A probability distribution can be estimated using the plurality of amplitude values, the corresponding time derivative values, and the corresponding frequency derivative values, and the entropy may be computed based on the probability distribution. The probability distribution may be estimated using a nearest-neighbor process. The time-varying data set may be smoothed prior to determining the boundaries of the speech segment. Determining the boundaries of the speech segment using the time-varying data set can include identifying a plurality of local minima in the time-varying data set, and identifying two consecutive local minima as the boundaries of the speech segment. The plurality of classes can include speech units, and processing the speech signal can include performing speech recognition. The plurality of classes can include representations of speech segments acquired from multiple speakers, and processing the speech signal can include performing speaker recognition.

Various implementations described herein may provide one or more of the following advantages. By leveraging information theory to analyze speech content, granularity of segmentation may be improved to detect intra-utterance speech units. Such intra-utterance speech units may in turn be used, for example, for improving accuracy of speech classification. The information theory based processes described herein may provide increased robustness to noise and distortion.

### BRIEF DESCRIPTION OF THE DRAWINGS

FIG. 1 is a block diagram of an example of a network-based speech processing system that can be used for implementing the technology described herein.

FIG. 2A is a spectral representation of speech captured over a duration of time.

FIG. 2B is a plot of a time-varying entropy function calculated from the spectral representation of FIG. 2A.

FIG. 2C is a smoothed version of the plot of FIG. 2B.

FIGS. 3A and 3B represent distributions of points in a three-dimensional space, wherein each point is calculated based on values corresponding to a particular time-point of the spectral representation of FIG. 2A.

FIG. 4 is a flowchart of an example process for classifying speech based on segments determined in accordance with the technology described herein.

FIG. 5 shows examples of a computing device and a mobile device.

### DETAILED DESCRIPTION

This document describes a segmentation technique in which segment boundaries are identified using statistics of the speech signal. For example, an information theory based approach may be used to calculate a time-varying entropy from a spectral representation of a speech signal. The entropy level is high during phonations and low during gaps or lack of phonation. Accordingly, local minima such as troughs in the time-varying entropy data, with one or more peaks in between, can be identified as segment boundaries. Such an information theory based approach may allow for identifying segment boundaries at a high granularity, e.g., within an utterance. In addition, because information content of noise is low, such an information theory based approach may also improve speech classification techniques by allowing for accurate and consistent segmentation in the presence of noise and distortions.

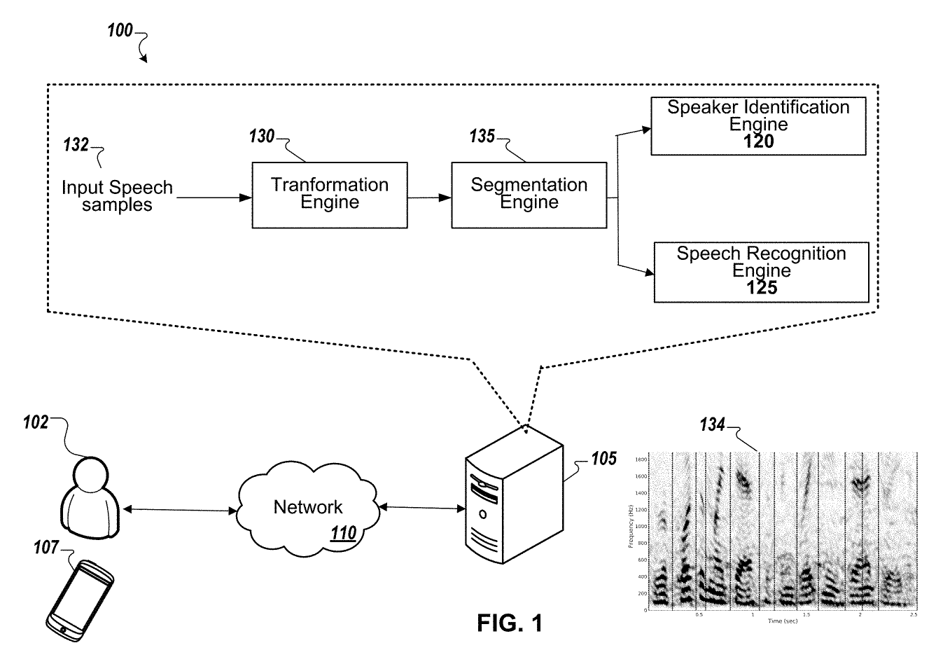

FIG. 1 is a block diagram of an example of a network-based speech processing system 100 that can be used for implementing the technology described herein. In some implementations, the system 100 can include a server 105 that executes one or more speech processing operations for a remote computing device such as a mobile device 107. For example, the mobile device 107 can be configured to capture the speech of a user 102, and transmit signals representing the captured speech over a network 110 to the server 105. The server 105 can be configured to process the signals received from the mobile device 107 to generate various types of information. For example, the server 105 can include a speaker identification engine 120 that can be configured to perform speaker recognition, and/or a speech recognition engine 125 that can be configured to perform speech recognition.

In some implementations, the server 105 can be a part of a distributed computing system (e.g., a cloud-based system) that provides speech processing operations as a service. For example, the server may process the signals received from the mobile device 107, and the outputs generated by the server 105 can be transmitted (e.g., over the network 110) back to the mobile device 107. In some cases, this may allow outputs of computationally intensive operations to be made available on resource-constrained devices such as the mobile device 107. For example, speech classification processes such as speaker identification and speech recognition can be implemented via a cooperative process between the mobile device 107 and the server 105, where most of the processing burden is outsourced to the server 105 but the output (e.g., an output generated based on recognized speech) is rendered on the mobile device 107. While FIG. 1 shows a single server 105, the distributed computing system may include multiple servers (e.g., a server farm). In some implementations, the technology described herein may also be implemented on a stand-alone computing device such as a laptop or desktop computer, or a mobile device such as a smartphone, tablet computer, or gaming device.

In some implementations, the server 105 includes a transformation engine 130 for generating a spectral representation of speech from input speech samples 132. In some implementations, the input speech samples 132 may be generated, for example, from the signals received from the mobile device 107. In some implementations, the input speech samples may be generated by the mobile device and provided to the server 105 over the network 110. In some implementations, the transformation engine 130 can be configured to process the input speech samples 132 to obtain a plurality of frequency representations, each corresponding to a particular time point, which together form a spectral representation of the speech signal. This can include computing corresponding frequency representations for a plurality of portions of the speech signal, and combining them together in a unified representation. For example, each of the frequency representations can be calculated using a portion of the input speech samples 132 within a sliding window of predetermined length (e.g., 60 ms). The frequency representations can be calculated periodically (e.g., every 10 ms), and combined to generate the unified representation. An example of such a unified representation is the spectral representation 134, where the x-axis represents frequencies and the y axis represents time. The amplitude of a particular frequency at a particular time is represented by the intensity or color or grayscale level of the corresponding point in the image. Therefore, a vertical slice that corresponds to a particular time point represents the frequency distribution of the speech at that particular time point, and the spectral representation in general represents the time variation of the frequency distributions.

The transformation engine 130 can be configured to generate the frequency representations in various ways. In some implementations, the transformation engine 130 can be configured to generate a spectral representation as outlined above. In some implementations, the spectral representation can be generated using one or more stationary spectrums. Such stationary spectrums are described in additional detail in U.S. application Ser. No. 14/969,029, filed on Dec. 15, 2015, the entire content of which is incorporated herein by reference. In some implementations, the transformation engine 130 can be configured to generate other forms of spectral representations (e.g., a spectrogram) that represent how the spectra of the speech varies with time.

In some implementations, speech classification processes such as speaker identification, speech recognition, or speaker verification entail dividing input speech into multiple small portions or segments. A segment may represent a coherent portion of the signal that is separated in some manner from other segments. For example, with speech, a segment may correspond to a portion of a signal where speech is present or where speech is phonated or voiced. For example, the spectral representation 134 illustrates a speech signal where the phonated portions are visible and the speech signal has been broken up into segments corresponding to the phonated portions of the signal. To classify a signal, each segment of the signal may be processed and the output of the processing of a segment may provide an indication, such as a likelihood or a score, that the segment corresponds to a class (e.g., corresponds to speech of a particular user). The scores for the segments may be combined to obtain an overall score for the input signal and to ultimately classify the input signal.

When processing a segment, a score can be generated for a segment, for example by comparing the segment with a pre-stored reference segment. For example, for text-dependent speaker recognition, a user may claim to be a particular person (claimed identity) and speak a prompt. Using the claimed identity, previously created reference segments corresponding to the claimed identity may be retrieved from a data store (the person corresponding to the claimed identity may have previously enrolled or provided audio samples of the prompt). Input segments may be created from an audio signal of the user speaking the prompt. The input segments may be compared with the reference segments to generate a score indicating a match (or lack thereof) between the user and the claimed identity.

In some cases, multiple input segments can form an utterance within an input speech. The technology described in this document facilitates a segmentation process in which segment boundaries are identified based on the statistics of the signal, thereby potentially allowing for identifying high-granularity segments within the utterances. In some implementations, this may allow for detection of small, natural units of speech that may not otherwise be detected using segmentation techniques that search for gaps within the speech. Leveraging the higher granularity of such units or segments may in some cases improve speech classification processes such as speech recognition and speaker identification.

The segments identified using the techniques described herein may perform better than fixed segments used in speech processing tasks, such as phonemes, phonemes in contexts (e.g., triphones), portions of phonemes, or combinations of phonemes. The fixed segments used in speech processing tasks may be referred to as speech units. The boundaries of speech units in speech may be fluid in that there may be ambiguity or uncertainty in indicating where one speech unit ends and the next speech unit begins. By contrast, the segments identified herein are determined based on the speech signal itself instead of definitions of speech units.

In some implementations, the server 105 includes a segmentation engine 135 that executes a segmentation process in accordance with the technology described herein. The segmentation engine can be configured to receive as input a spectral representation that includes a frequency domain representation for each of multiple time points (e.g., the spectral representation 134 as generated by the transformation engine 130), and generate outputs that represent segment boundaries (e.g., as time points) within the input speech samples 132. The identified segment boundaries can then be provided to one or more speech classification engines (e.g., the speaker identification engine 120 or the speech recognition engine 125) that further process the input speech samples 132 in accordance with the corresponding speech segments.

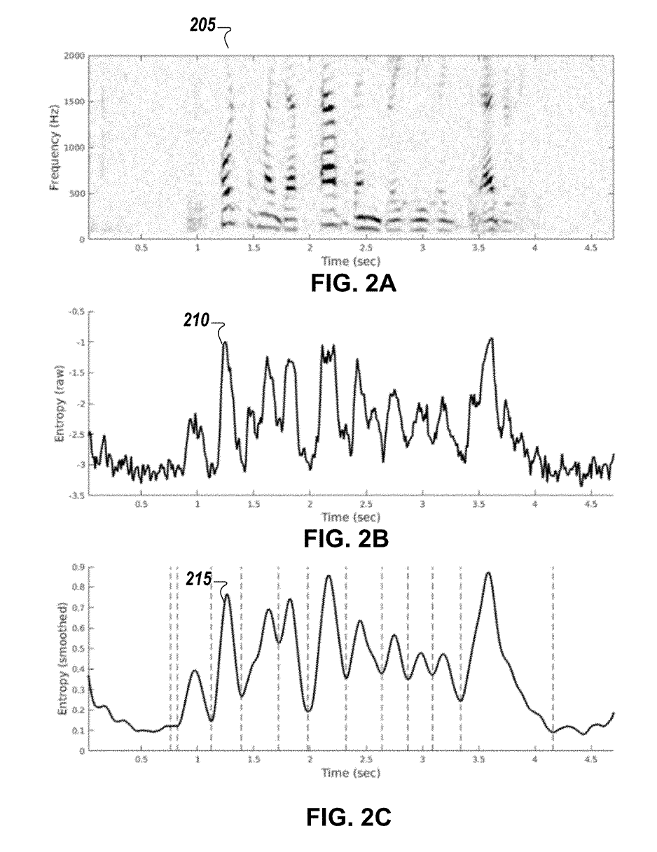

FIGS. 2A-2C illustrate an example of how the segmentation engine 135 generates identification of segment boundaries in input speech. Specifically, FIG. 2A is a spectral representation 205 corresponding to speech captured over a duration of time, FIG. 2B is a plot 210 of a time-varying entropy function calculated from the spectral representation of FIG. 2A, and FIG. 2C is a smoothed version 215 of the plot of FIG. 2B. The x-axis of the spectral representation 205 represents time, and the y-axis represents frequencies. Therefore, the data corresponding to a vertical slice for a given time point represents the frequency distribution at that time point. In some implementations the frequency representation may be a stationary spectrum as described in U.S. application Ser. No. 14/969,029, filed on Dec. 15, 2015, the entire content of which is incorporated herein by reference. The technology described herein includes representing a spectrum, such as a stationary spectrum, as a collection of points in a predefined space, and tracking the time variation of the distribution of such points, wherein each time point corresponds to a spectrum at a different time point. The tracking may be done, for example, by calculating a time-varying statistic, a particular value of which represents the distribution of points at a given time point. In one example, the statistic used is self-information or entropy, which yields the time varying plot 210 illustrated in FIG. 2B. The plot 210 can then be smoothed to generate the plot 215, which serves as a basis for identifying the segment boundaries in the input speech that produced the spectral representation 205.

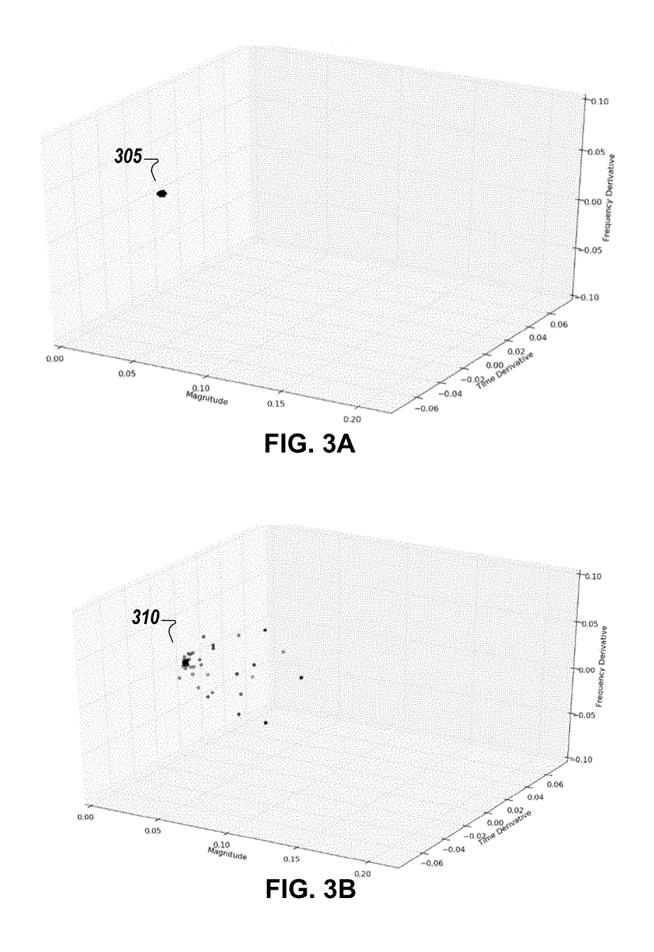

In some implementations, a spectrum can be represented as a collection of points in a three dimensional phase space where the three dimensions are magnitude, time derivative of the magnitude, and frequency derivative of the magnitude, respectively. These quantities may be denoted as mᵢ, \dot{m}ᵢ^{t}, and \dot{m}ᵢ^{ω}, respectively. To represent a spectrum as a point in this space, the frequency information is discarded, and the magnitude values corresponding to the different frequencies are retained. For each magnitude value, a time derivative value and a frequency derivative value are computed, which results in each magnitude value of a spectrum being represented by a set of three values. This triad of values is then used to plot a corresponding point in the phase space defined above. This is repeated for each magnitude value of the spectrum, and the spectrum is therefore represented as a collection of points in the phase space. In the absence of a phonation, e.g., during a gap in phonation, all three variables have low values, and the corresponding points are typically clustered close to one another. This is illustrated in FIG. 3A, which shows the distribution 305 of points at one particular time instant when phonation is not present. On the other hand, in the presence of a phonation, at least some of the points have relatively larger values, and the distribution is dispersed. This is illustrated in FIG. 3B, which shows the distribution 310 of points at one particular time instant when phonation is present. The clustering and dispersion may alternate based on an absence and presence, respectively, of phonation, and may be represented using a statistic indicative of the extent of dispersion (or clustering). If such a statistic can be directly calculated from the distribution of points, a presence or absence of phonation may be determined from the time variation of the statistic, and hence be used to identify segment boundaries.

In some implementations, the statistic that is used for representing a given distribution of points is entropy, which is indicative of an expected value of self-information in the distribution of points. In information theory, self-information is defined as:

I(x)=−log p(x) (1)

Self-information may be interpreted as an amount of uncertainty or surprise, given a sequence of independent observations, of the next observation.

Entropy is defined as an expected value of self-information over a partition of the outcome space. For a discrete random variable X, entropy is given by:

$$h = - {\sum }_{x ∈ X} p ( x ) log p ( x ) \qquad ( 2 )$$

For a continuous variable, the entropy is given by:

$$h = - {\int }_{x ∈ X} f ( x ) log f ( x ) dx \qquad ( 3 )$$

For a given set of points X={x₁, x₂, . . . , x_{N}}, the entropy is given by:

$$h = - \frac{1}{N} {\sum }_{i = 1}^{N} log f ( {x}_{i} ) \qquad ( 4 )$$

The probability density f(xᵢ) of each point xᵢ can be found in various ways. For example, a nearest neighbor density approach may be used to determine the probability density. In this approach, given a spherical volume or ball B (also referred to as a hypersphere), and a random variable X with density f=f_{X}, the probability of the random variable being in the spherical volume is the integral of the density over the volume, which is given as:

[symbol]

(XεB)=∫_{B}f_{X}(x)dV, (5)

Assuming that the density is constant over a small volume x₀, this is approximated as:

[symbol]

(XεB)=∫_{B}f_{X}(x)dV≈V(B)f_{X}(x₀) (6)

where V(B) is the volume of B. If k observations of N independent observations of the random variable X lie within the spherical volume B, equation (6) may be approximated as:

$$ℙ ( X ∈ B ) \approx \frac{k}{N} \qquad ( 7 )$$

Therefore, combining equations (6) and (7), the density estimation is given by:

$$f ( {x}_{0} ) \approx \frac{k}{NV ( B )} \qquad ( 8 )$$

For a given set of points X={x₁, x₂, . . . , x_{N}}, an approximation \hat{f}(xᵢ) that excludes xᵢ but encloses its nearest neighbor, is given by:

$$\hat{f} ( {x}_{i} ) := \frac{1}{( N - 1 ) {V}_{i}} \qquad ( 9 )$$

where Vᵢ is the spherical volume centered at xᵢ and just encloses the nearest neighbor of xᵢ. The general expression for the volume of the hypersphere is:

$$V ( ρ , r ) = \frac{{ρ}^{r} {π}^{\frac{r}{2}}}{Γ ( r / 2 + 1 )} \qquad ( 10 )$$

where r is the dimension of the space, p is the radius of the hypersphere, and Γ is the gamma function. Combining Equations (9) and (10) yields:

$$\hat{f} ( {x}_{i} ) = [ \frac{Γ ( r / 2 + 1 )}{( N - 1 ) {Δ}_{i}^{r} {π}^{r / 2}} ] \qquad ( 11 )$$

where Δᵢ is the distance to the nearest neighbor.
Substituting this in equation (4) yields:

$$h = - \frac{1}{N} {\sum }_{i = 1}^{N} log [ \frac{Γ ( r / 2 + 1 )}{( N - 1 ) {π}^{r / 2}} ] - \frac{1}{N} {\sum }_{i = 1}^{N} log [ \frac{1}{{Δ}_{i}^{r}} ] \qquad ( 12 )$$

Upon further simplification, equation (12) reduces to:

$$h = \frac{r}{N} {\sum }_{i = 1}^{N} log {Δ}_{i} + log [ \frac{( N - 1 ) {π}^{r / 2}}{Γ ( r / 2 + 1 )} ] \qquad ( 11 )$$

The entropy value calculation for multiple spectrums (e.g., spectrums corresponding to multiple time points) using equation (11) generates a time-varying function such as the one represented by the plot 210 in FIG. 2B. The entropy drops to a low value during silent regions (e.g., regions in between syllables of speech) and also dips within a given utterance at natural breaks in harmonics, for example at an unvoiced consonant inside a word. Therefore, local minima or nadirs in the time-varying plot may be identified as segment boundaries. Such identification of local minima may be referred to as notching. In some implementations, the plot corresponding to the raw entropy estimates may be significantly jagged (e.g., as illustrated by the plot 210 in FIG. 2B), and include random local fluctuations. Identifying segment boundaries from such a plot may lead to the identification of spurious segment boundaries. In such cases, the raw entropy data may be smoothed using a smoothing process to remove the random fluctuations and potentially make the data amenable to more reliable notching. For example, only nadirs with fairly large extent to them may be trusted as being indicative of segment boundaries, and hence, only the ones that survive the smoothing process can be used in estimating such boundaries. The plot 215 in FIG. 2C represents an example of smoothed data used for identifying segment boundaries.

Various smoothing processes may be used for the purposes described herein. In some implementations, the smoothing process may include convolving the raw data with a window function. The width, shape and size of the window function may be chosen in accordance with one or more practical considerations. For example, because in some cases, the correlation time of human speech is about 140 milliseconds, a smoothing window of the same or comparable size may be used to smooth rapidly-varying noise while keeping intact the true variation caused by the speaker's voice. In an example mode of operation, then, a window, with the window half-width set to 6 time points, may be used. Other smaller or larger windows (e.g., windows with half width of 3 or 9) may also be used.

In some implementations, multiple smoothing windows may be used for smoothing the data, and the consistent nadirs and peaks may be used in the notching process. The consistency may also be determined using pre-stored information (e.g. training data) indicative of past experience. For example, the number of segments per unit time may be determined for each window, and the result compared to measurements of segment density calculated from training data that reflects satisfactory segmentation. The width of a smoothing window can also be selected based on such training data. For example, a range of smoothing window widths (for example, from half-width equal to 3 to 12 time points) can be tried, and the resulting segment densities can be compared to a template density calculated from the training data. The window width that corresponds closely to the template density may then be used.

In some implementations, a noise floor may be estimated at a nadir or local minima detected using the notching process, and the particular nadir may be excluded as being indicative of a segment boundary if the noise floor is above a predetermined threshold. A noise floor estimation technique, which uses the absolute magnitude of stationary spectrums to estimate the noise floor is described in U.S. patent application Ser. No. 14/860,999, filed on Sep. 22, 2015, the entire content of which is incorporated herein by reference.

Overall, the primary example described above focuses on estimating a probability distribution (PDF) for a spectrum using a nonparametric nearest neighbor technique, and then computing an entropy of the estimated PDF. The calculation is done separately at each time point for which data is available in the corresponding spectral representation. During silent periods, when only background noise may be present, the PDF is relatively compact, and results in small entropy values. During phonation, both noise and high amplitude harmonics of the voice may be present, and hence the PDF extends across the phase space, and results in a relatively larger entropy. Equation (11) provides an estimate of the entropy of the spectrum (e.g., a stationary spectrum) at one time instant as a function of the nearest-neighbor distances Δᵢ. Therefore, the PDF itself need not be calculated in a separate step because equation 11 implicitly accounts for the PDF in generating the estimate for the entropy.

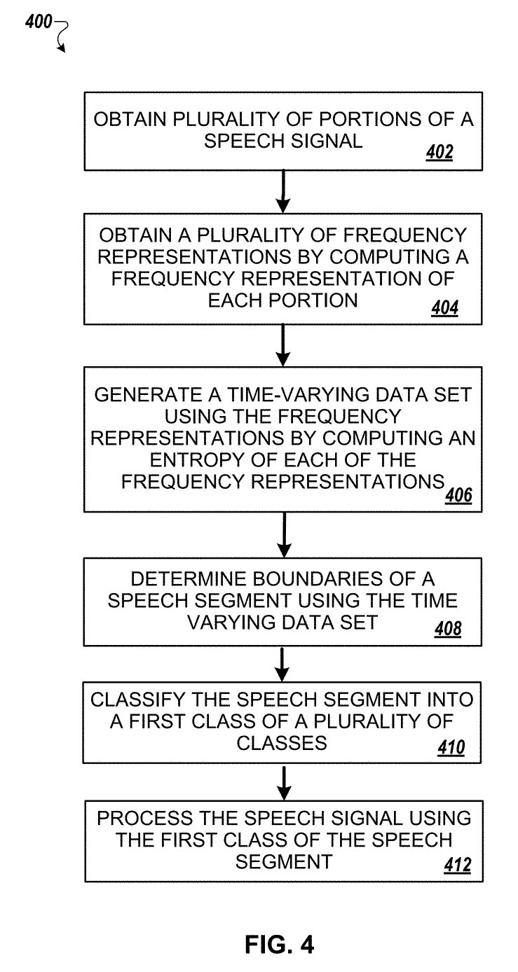

FIG. 4 is a flowchart illustrating an example implementation of a process 400 for classifying speech based on segments determined in accordance with the technology described herein. In some implementations, at least a portion of the process 400 may be implemented on a server 105, for example, by the transformation engine 130 and the segmentation engine 135. Operations of the process 400 include obtaining a plurality of portions of a speech signal (402). In some implementations, incoming speech signal may be divided into smaller portions using, for example, a sliding window of a predetermined length. For example, each of the plurality of portions can correspond to the input speech samples within a sliding window of predetermined length (e.g., 60 ms). The sliding window can be moved periodically (e.g., every 10 ms), to generate the plurality of portions of the speech signal. In some implementations, the plurality of portions together corresponds to an utterance represented within the speech signal.

Operations of the process 400 includes obtaining a plurality of frequency representations by computing a frequency representation of each portion (404). In some implementations, the frequency representations can be computed by the transformation engine 130 described with reference to FIG. 1. In some implementations, computing the frequency representation can include computing a stationary spectrum for the corresponding portion. In computing the frequency representation of a portion, a plurality of frequency domain components can be computed from time domain values representing features in the portion of the speech. This can include, for example, multiple amplitude values each of which corresponds to a different frequency. The plurality of frequency representations may together form a spectral representation for the duration of speech represented by the plurality of portions of the speech signal.

Operations of the process 400 also includes generating a time-varying data set using the plurality of frequency representations by computing an entropy of each of the frequency representations (406). This can include, for example, obtaining a plurality of amplitude values from the frequency representation, computing, for each of the plurality of amplitude values, a corresponding time derivative value and a corresponding frequency derivative value, and computing the entropy using the plurality of amplitude values, the corresponding time derivative values, and the corresponding frequency derivative values. The plurality of amplitude values can be obtained from the frequency representation by discarding the frequency information associated with amplitude values. In some implementations, the entropy can be calculated by mapping the data points on to a three dimensional space, wherein the dimensions represent amplitude value, time derivative value, and frequency derivative value, respectively, estimating a probability distribution from the distribution of the data points in the three dimensional space, and computing, the entropy based on the probability distribution. In some implementations, the probability distribution need not be separately calculated. For example, the entropy of the distribution of the data points may be calculated using a nearest-neighbor process, for example, using equation (11) described above.

Operations of the process 400 also includes determining boundaries of a speech segment using the time-varying data set (408). In some implementations, the time-varying data set may be smoothed, for example using a window function, prior to determining the boundaries of the speech segment. Determining the boundaries of the speech segment using the time-varying data set can include identifying a plurality of local minima in the time-varying data set, and identifying two consecutive local minima as the boundaries of the speech segment. The process of identifying the local minima in the time-varying data set may be referred to as notching, which has been described above.

Operations of the process 400 also includes classifying the speech segment into a first class of a plurality of classes (410). This can be done, for example, by generating a score or metric values based on comparing the speech segment with a model for the corresponding classes, and determining, based on the multiple scores or metric values that the speech segment likely belongs to one of the plurality of classes. The classes may be defined based on the particular application the technology is being used for. For example, in speech recognitions, the classes can each represent a speech unit (e.g., portions or combinations of a phoneme, a diphone, triphone, etc.), and the speech segment can be compared with each of the classes to identify a likely class that the segment belongs to. In speaker recognition applications, the classes can correspond to template or reference segments of speech obtained from the pool of possible speakers, and the speech segment is compared with each of such reference segments to determine the likely class to which it belongs.

Operations of the process 400 further includes processing the speech signal using the first class of the speech segment (412). The processing may include, for example, speech recognition, speaker identification, and speaker verification. For example, in speech recognition, once the speech segment is identified as belonging to a particular class, the speech unit can be used as a building block in the speech recognition process. In another example, in speaker identification, once the speech segment is identified as belonging to a particular class, the speaker associated with the particular class can be identified as a speaker of the speech segment. In some implementations, the classification may be performed by a speaker identification engine 120 or a speech recognition engine 125 described above with reference to FIG. 1. Because the technology described herein may allow for identifying boundaries of speech segments shorter than utterances, the resulting high-granularity speech segments may improve such speech classification processes by making the processes more robust to noise and distortions.

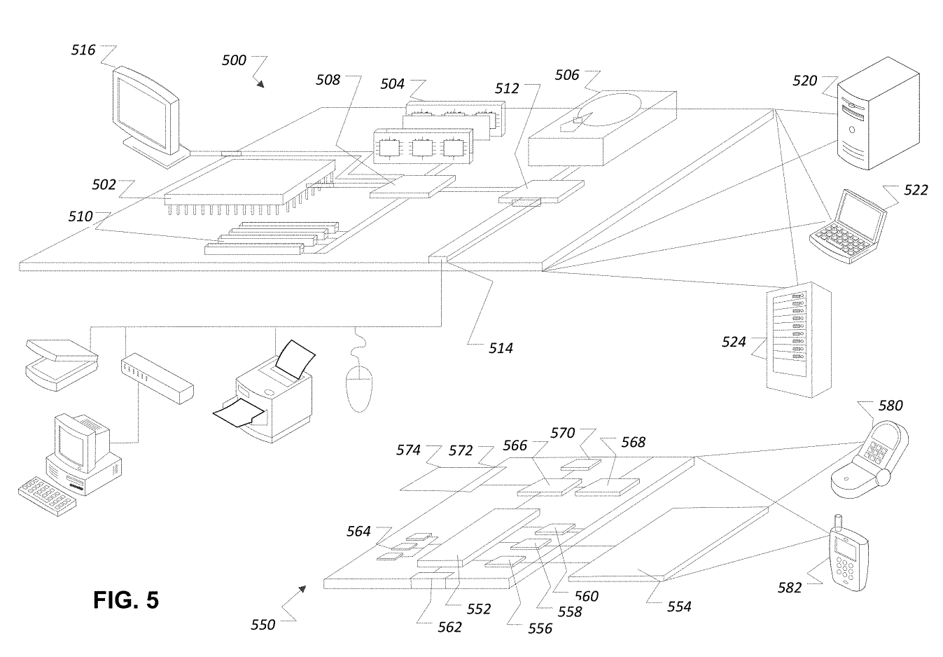

FIG. 5 shows an example of a computing device 500 and a mobile device 550, which may be used with the techniques described here. For example, referring to FIG. 1, the transformation engine 130, segmentation engine 135, speaker identification engine 120, and speech recognition engine 125, or the server 105 could be examples of the computing device 500. The device 100 could be an example of the mobile device 550. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, tablet computers, e-readers, and other similar portable computing devices. The components shown here, their connections and relationships, and their functions, are meant to be examples only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a non-transitory computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device, such as the device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wi-Fi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through an acoustic transducer or speaker, e.g., in a handset of device 550. Such sound may include sound from voice telephone calls, may include recorded sound (e.g., voice messages, music files, and so forth) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can be implemented in combination in a single implementation. Conversely, various features that are described in the context of a single implementation can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. For example, while the above description primarily uses the example of entropy as a statistic that is indicative of phonation and gaps, other statistics may also be used without deviating from the scope of the technology. The corresponding time-varying functions can be in general referred to as stripe functions. Examples of other stripe functions are described, for example, in U.S. patent application Ser. No. 15/181,868, filed on Jun. 14, 2016, the entire content of which is incorporated herein by reference.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As such, other implementations are within the scope of the following claims.

What is claimed is:

1. A computer-implemented method comprising:
obtaining a plurality of portions of a speech signal;
obtaining a plurality of frequency representations by computing a frequency representation of each portion of the speech signal;
generating, by one or more processing devices, a time-varying data set using the plurality of frequency representations by computing an entropy of each frequency representation of the plurality of frequency representations;
determining, by the one or more processing devices, boundaries of a speech segment using the time-varying data set;
classifying the speech segment into a first class of a plurality of classes; and
processing the speech signal using the first class of the speech segment.

2. The method of claim 1, wherein computing the frequency representation comprises computing a stationary spectrum.

3. The method of claim 1, wherein computing the entropy for each frequency representation comprises:
obtaining a plurality of amplitude values from the frequency representation;
computing, for each of the plurality of amplitude values, a corresponding time derivative value and a corresponding frequency derivative value; and
computing the entropy using the plurality of amplitude values, the corresponding time derivative values, and the corresponding frequency derivative values.

4. The method of claim 3, comprising:
estimating a probability distribution using the plurality of amplitude values, the corresponding time derivative values, and the corresponding frequency derivative values; and
computing the entropy based on the probability distribution.

5. The method of claim 4, wherein the probability distribution is estimated using a nearest-neighbor process.

6. The method of claim 1 further comprising smoothing the time-varying data set prior to determining the boundaries of the speech segment.

7. The method of claim 1, wherein determining the boundaries of the speech segment using the time-varying data set comprises:
identifying a plurality of local minima in the time-varying data set; and
identifying two consecutive local minima as the boundaries of the speech segment.

8. The method of claim 1, wherein the plurality of classes comprises speech units, and processing the speech signal comprises performing speech recognition.

9. The method of claim 1, wherein the plurality of classes comprises representations of speech segments acquired from multiple speakers, and processing the speech signal comprises performing speaker recognition.

10. A system comprising:
memory; and
one or more processing devices configured to:
obtain a plurality of portions of a speech signal,
obtain a plurality of frequency representations by computing a frequency representation of each portion of the speech signal,
generate a time-varying data set using the plurality of frequency representations by computing an entropy of each frequency representation of the plurality of frequency representations,
determine boundaries of a speech segment using the time-varying data set;
classify the speech segment into a first class of a plurality of classes, and
process the speech signal using the first class of the speech segment.

11. The system of claim 10, wherein computing the frequency representation comprises computing a stationary spectrum.

12. The system of claim 10, wherein computing the entropy for each frequency representation comprises:
obtaining a plurality of amplitude values from the frequency representation;
computing, for each of the plurality of amplitude values, a corresponding time derivative value and a corresponding frequency derivative value; and
computing the entropy using the plurality of amplitude values, the corresponding time derivative values, and the corresponding frequency derivative values.

13. The system of claim 12, wherein the one or more processing devices are configured to:
estimate a probability distribution using the plurality of amplitude values, the corresponding time derivative values, and the corresponding frequency derivative values; and
compute the entropy based on the probability distribution.

14. The system of claim 13, wherein the probability distribution is estimated using a nearest-neighbor process.

15. The system of claim 10, wherein the one or more processing devices are configured to smooth the time-varying data set prior to determining the boundaries of the speech segment.

16. The system of claim 10, wherein determining the boundaries of the speech segment using the time-varying data set comprises:
identifying a plurality of local minima in the time-varying data set; and
identifying two consecutive local minima as the boundaries of the speech segment.

17. The system of claim 10, wherein the plurality of classes comprises speech units, and processing the speech signal comprises performing speech recognition.

18. The system of claim 10, wherein the plurality of classes comprises representations of speech segments acquired from multiple speakers, and processing the speech signal comprises performing speaker recognition.

19. One or more machine-readable storage devices having encoded thereon computer readable instructions for causing one or more processors to perform operations comprising:
obtaining a plurality of portions of a speech signal;
obtaining a plurality of frequency representations by computing a frequency representation of each portion of the speech signal;
generating a time-varying data set using the plurality of frequency representations by computing an entropy of each frequency representation of the plurality of frequency representations;
determining boundaries of a speech segment using the time-varying data set;
classifying the speech segment into a first class of a plurality of classes; and
processing the speech signal using the first class of the speech segment.

20. The one or more machine-readable storage devices of claim 19, wherein computing the entropy for each frequency representation comprises:
obtaining a plurality of amplitude values from the frequency representation;
computing, for each of the plurality of amplitude values, a corresponding time derivative value and a corresponding frequency derivative value; and
computing the entropy using the plurality of amplitude values, the corresponding time derivative values, and the corresponding frequency derivative values.
